(19) United States
(12) Patent Application Publication
(10) Pub. No.: US 2025/0311889 A1
(43) Pub. Date: Oct. 9, 2025

(54) BLADE DROP DETECTION FOR A MICRO PUREE MACHINE

(71) Applicant: SharkNinja Operating LLC, Needham, MA (US)

(72) Inventors: Jonathan James, Providence, RI (US); Nathan Lyell, Brighton, MA (US)

(73) Assignee: SharkNinja Operating LLC, Needham, MA (US)

(21) Appl. No.: 18/627,745

(22) Filed: Apr. 5, 2024

(51) Int. Cl. A47J 43/07; A47J 43/044; A47J 43/08

(52) U.S. Cl. CPC A47J 43/0755; A47J 43/044; A47J 43/082; A47J 2043/04472; A47J 2043/0449

(57) ABSTRACT

An example food processing system is provided. The food processing system include a housing. A drive shaft extends from the housing. The drive shaft includes a first end configured to receive a blade assembly and a second end opposing the first end. At least one sensor is configured to detect a position of the second end of the drive shaft to determine if the blade assembly is coupled to the drive shaft or not.

### FIELD

The present disclosure relates to a food processing device and, more particularly, to a micro puree machine configured to detect when a mixing blade is disconnected from a mixing shaft.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are impractical for preparing most non-dessert food products.

An alternative type of machine known for making a frozen food product is what is referred to herein as a micro-puree machine. Typically, machines of this nature spin and plunge a blade into a pre-frozen ingredient or combination of ingredients. While able to make frozen desserts like ice creams, gelatos, frozen yogurts, sorbets and the like, micro puree style machines can also prepare non-dessert types of foods such as non-dessert purees and mousses.

### SUMMARY

An example food processing system is provided. The food processing system include a housing. A drive shaft extends from the housing. The drive shaft includes a first end configured to receive a blade assembly and a second end opposing the first end. At least one sensor is configured to detect a position of the second end of the drive shaft to determine if the blade assembly is coupled to the drive shaft or not.

In some implementations, the drive shaft may include an inner shaft and an outer shaft. The drive shaft may include a coupling at the first end configured to couple the drive shaft to the blade assembly. The drive shaft may include a magnet coupled at about the second end. The second end of the drive shaft may be in a first position relative to the sensor when the blade assembly is coupled to the drive shaft and the second end of the drive shaft is in a second position relative to the sensor when the blade assembly is not coupled to the drive shaft. The sensor determines if the blade assembly may be coupled to the drive shaft or not coupled to the drive shaft by determining if the second end of the drive shaft is in the first position or the second position. The sensor may determine that the blade assembly is not coupled to the drive shaft by detecting a magnetic field within its proximity caused a magnet positioned at about the second end of the drive shaft. The sensor may determine that the blade assembly is coupled to the drive shaft by determining an absence of a magnetic field within its proximity. The drive shaft may be coupled to at least one spring. The at least one spring may be configured to exert a force against the drive shaft that pushes the second end of the drive shaft toward the sensor. When the blade assembly is coupled to the drive shaft, the force of the at least one spring may be overcome by the coupling of the blade assembly to prevent the at least one spring from pushing the second end of the drive shaft toward the sensor. When the blade assembly is decoupled from the drive shaft, a force of the at least one spring may push the second end of the drive shaft into sufficient proximity of the sensor whereby the sensor detects the magnetic field of the magnet and the sensor determines that the blade assembly is not coupled to the drive shaft.

An example food processing system is provided. The food processing system includes a housing. A drive shaft extends from the housing. The drive shaft includes a first end configured to receive a blade assembly and a second end opposing the first end. At least one sensor configured to detect a position of the second end of the drive shaft. The second end of the drive shaft is in a first position relative to the sensor when the drive shaft is extending into a mixing container and the second end of the drive shaft is in a second position relative to the sensor when movement of the drive shaft into the container is inhibited by a threshold resistive force.

In some implementations, the threshold resistive force may be determined by a spring force of at least one spring coupled to the drive shaft. The at least one spring may provide a force that pushes the drive shaft away from the sensor. The resistive force may be caused by at least one of a dropped blade assembly, a hard object, and a hard food product. The sensor may include one of a magnetic sensor and a contact switch. The drive shaft may include a coupling at the first end configured to couple the drive shaft to the blade assembly. The food processing system may include a controller. When the sensor detects that the threshold resistive force has been reached or exceeded, the controller may deactivate the drive motor and a position motor. The resistive forces, using the at least one sensor, may be determined by changes in length of the at least one spring in the housing. When the changes in the length of the at least one spring surpasses a threshold, power to the drive motor may be ceased.

An example food processing system is provided. The food processing system includes a lid and a blade assembly within the lid. An extended drive shaft is configured to determine whether the blade assembly is fully engaged within the lid. When the blade assembly is not fully engaged with the lid, the extended drive shaft fully disengages the blade assembly from the lid and drive motor ceases further operation. Otherwise, the extended drive shaft fully engages with the blade assembly to perform a food processing operation.

In some implementations, when the extended drive shaft is fully engaged with the blade assembly, at least two clips of the lid may be engaged with the extended drive shaft. The lid may include at least one lever, and when the extended drive shaft is fully engaged with the blade assembly and the blade assembly is fully engaged with the lid, the at least one lever of the lid may be rotated to an actuating position. The lid may include at least one lever, and when the extended drive shaft is not fully engaged with the blade assembly and pushes the blade assembly out of the lid, the at least one lever of the lid may be rotated to a non-actuating position.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1A is an isometric view of a device according to an exemplary embodiment of the present disclosure including a bowl assembly and lid assembly;

FIG. 1B is another isometric view of the device of FIG. 1A without the bowl assembly and lid assembly;

FIGS. 2A and 2B are detailed views of the coupling (FIG. 2A) and the bowl (FIG. 2B) of the micro puree machine of FIG. 1A according to some embodiments of the disclosure;

FIG. 3A shows an assembled view of the reversible bowl assembly of the micro puree machine of FIG. 1A according to some embodiments of the disclosure;

FIG. 3B is a detailed view of the blade of the reversible bowl assembly of FIG. 3A according to some embodiments of the disclosure;

FIG. 3C is a cut-away view of the reversible bowl assembly of FIG. 3A showing an extrusion assembly according to some embodiments of the disclosure;

FIG. 3D is a detailed view of the plunger of the extrusion assembly of FIG. 3C according to some embodiments of the disclosure;

FIGS. 4A and 4B illustrate the use of the reversible bowl assembly of FIG. 3A according to some embodiments of the disclosure;

FIGS. 4C illustrates the use of another bowl assembly including the extrusion assembly according to some embodiments of the disclosure;

FIG. 5A illustrates a cross-sectional view of a micro puree machine including a kill switch configured to detect when a drive shaft is obstructed from moving downward within a mixing container;

FIG. 5B illustrates the arrangement a drive shaft of a micro puree machine when kill switch is not activated;

FIG. 5C illustrates an arrangement of the drive shaft where a kill switch is activated when a blade is dropped

FIGS. 6A-6C illustrates an alternative configuration of a drive shaft and sensor used to detect when the drive shaft downward movement in a container is blocked;

FIGS. 7A-7D illustrate an example extended drive shaft used to determine if a blade assembly is properly positioned in a lid;

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

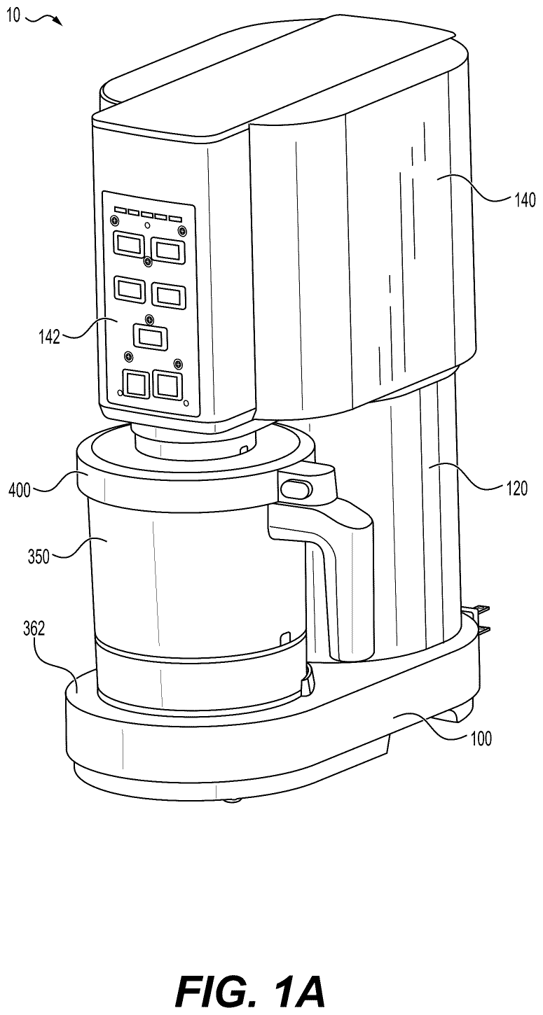

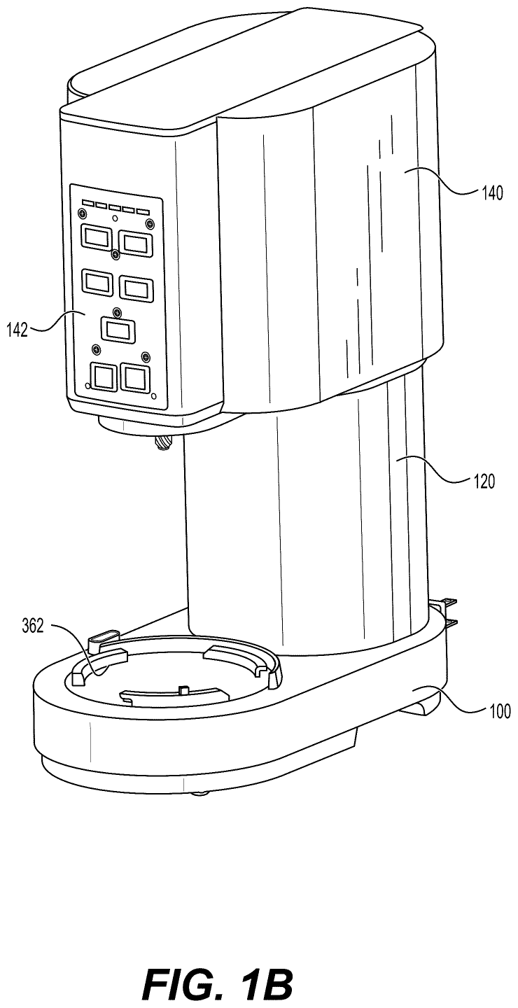

FIG. 1A shows an isometric view of a device 10 according to an exemplary embodiment of the present disclosure. The device 10 includes a lower housing or base 100 and an upper housing 140. A middle housing 120 extends between the lower housing 100 and upper housing 140. The upper housing 140 includes an interface 142 for receiving user inputs to control the device 10 and/or display information. The device 10 includes a removable bowl assembly 350 and lid assembly 400 on the base 100. FIG. 1B shows the device 10 with the bowl assembly 350 and lid assembly 400 removed.

As further described herein, the bowl assembly 350 receives one or more ingredients for processing. The bowl assembly 350 and lid assembly 400 are placed on the lower housing 100 as show in FIG. 1A. The bowl assembly 350 and lid assembly 400 are rotatable on a lifting platform 362 from a down position to an up position, and vice versa.

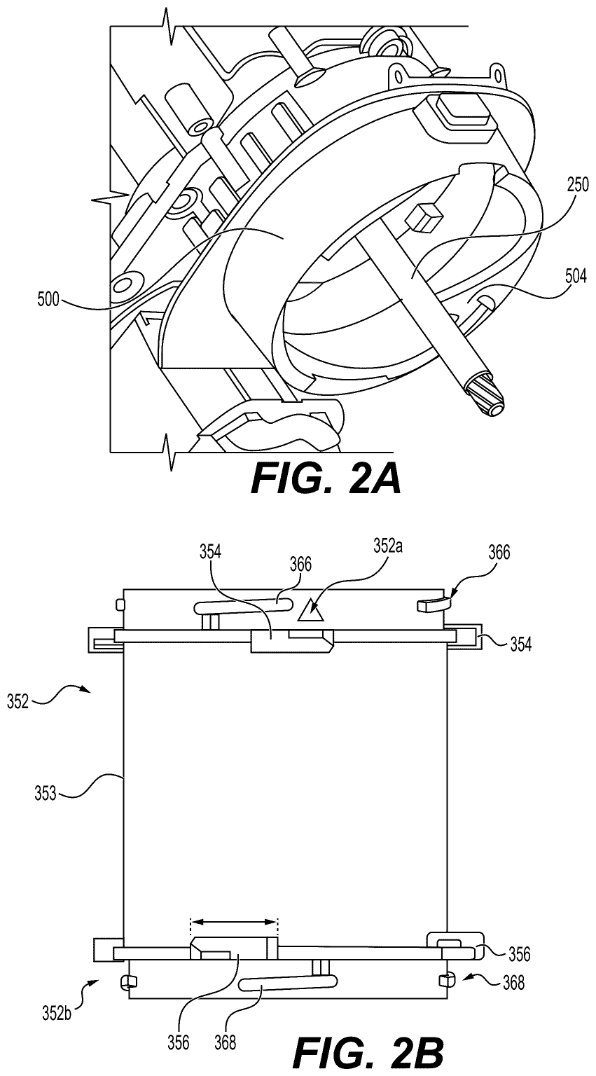

FIG. 2A illustrates an embodiment of a portion of a micro-puree machine including a coupling 500′ for coupling to a bowl assembly, for example, a reversible bowl assembly, in accordance with some embodiments of the disclosure. FIG. 2B illustrates an embodiment of a reversible bowl 352″ that may be coupled to coupling 500′. The bowl 352″ may include any of a variety of external surfaces. For example, embodiments of the bowl may have a ribbed or corrugated surface (e.g., like bowl 352 or 352′), or a smooth surface (e.g., bowl 352″). Similarly, bowls 352 and 352″ may have any variety of surfaces, including smooth surfaces.

As shown in FIG. 2A, the driven shaft 250 of the micro-puree machine 10 may extend from the housing 120 into an interior of the coupling 500′ and optionally all the way through the interior of the coupling 500′. The inner surface 502′ of the coupling 500′ may comprise one or more slots 504 sized and shaped to receive at least one projection 354 on an outer surface of a first open end 352a″ of the bowl 352″. In embodiments, both the first end 352a″ and the second end 352b″ of the bowl 352″ may be open—that is, both the first end 352a″ and the second end 352b″ may not have a top or bottom wall and/or a lid. However, the disclosure is not so limited, and one or both ends 352a″, 352b″ of the bowl 352″ may be closed with a wall or a lid. In embodiments, the at least one projection 354″ on the bowl 352″ may be four projections 354 spaced 90 degrees apart about an outer surface of the first end 352a″ of the bowl 352″. However, the disclosure contemplates more or fewer than four projections 354. In a first configuration of the reversible bowl assembly 350″, the user may rotate the bowl 352″ relative to the coupling 500′ such that the projections 354 are rotated into the slots 504, coupling (e.g., locking) the bowl 352″ and the coupling 500 together.

The slots 504 also may be sized and shaped to receive at least one projection 356 on an outer surface of a second open end 352b″ of the bowl 352″. In embodiments, the at least one projection 356 may be four projections 356 spaced 90 degrees apart about an outer surface of the second end 352b″ of the bowl 352″. However, the disclosure contemplates more or fewer than four projections 356. In a second configuration of the reversible bowl assembly 350″, the user may rotate the bowl 352″ relative to the coupling 500′ such that the projections 356 are rotated into the slots 504, coupling (e.g., locking) the bowl 352″ and the coupling 500′ together. The first end 352a″ of the bowl 352″ may further comprise threads 366 for coupling to a first lid, while the second end 352b″ of the bowl 352″ may comprise threads 368 for coupling to a second lid, as further described elsewhere herein.

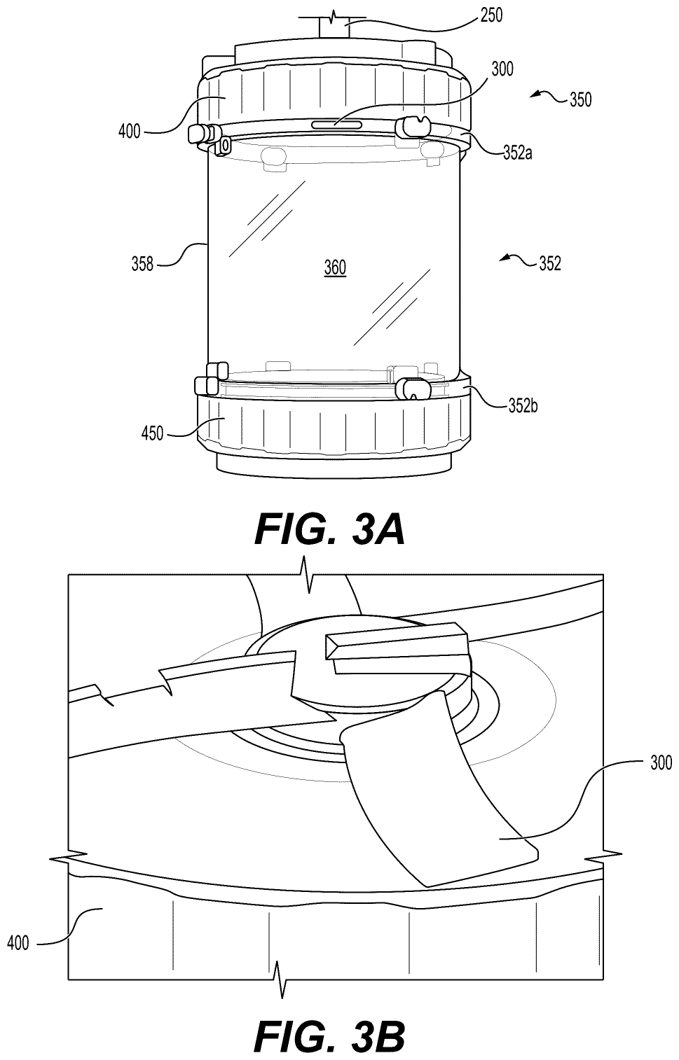

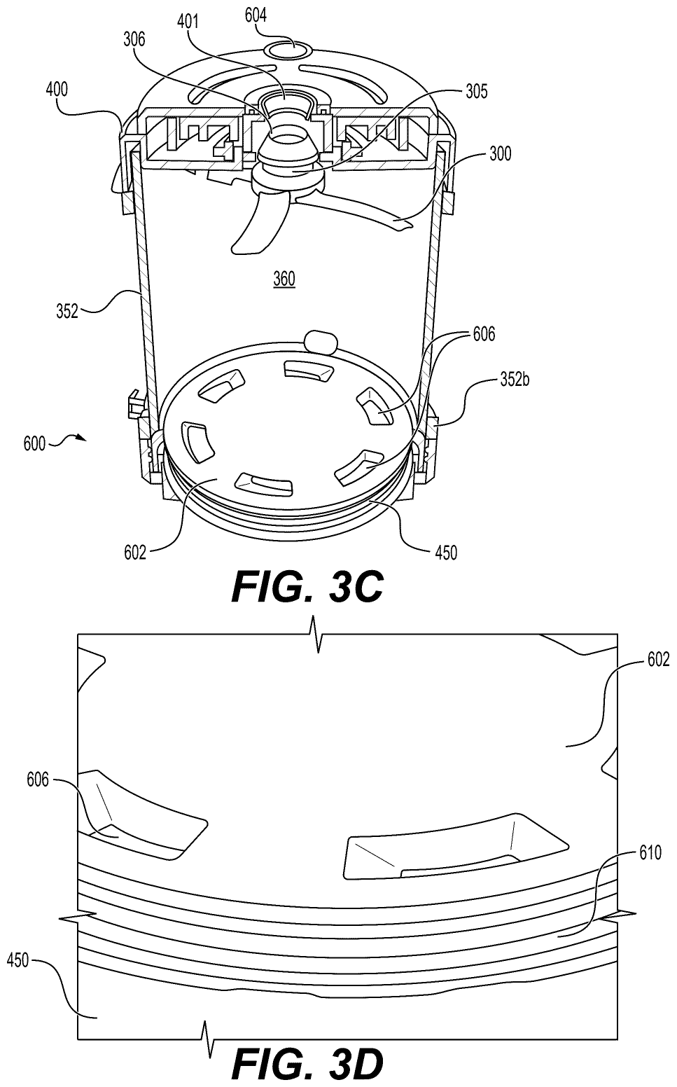

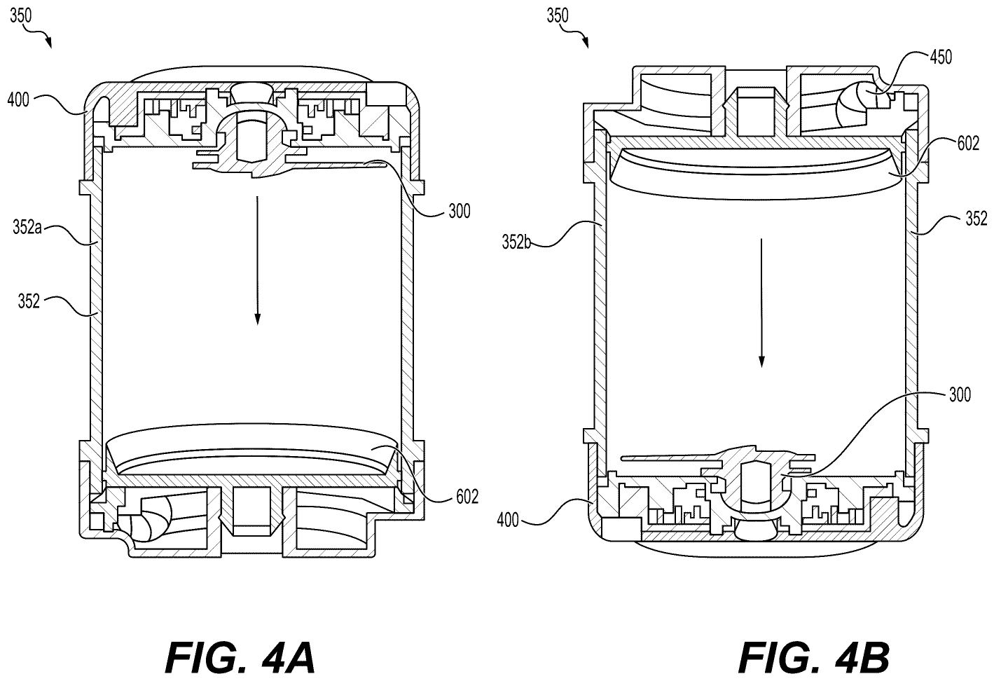

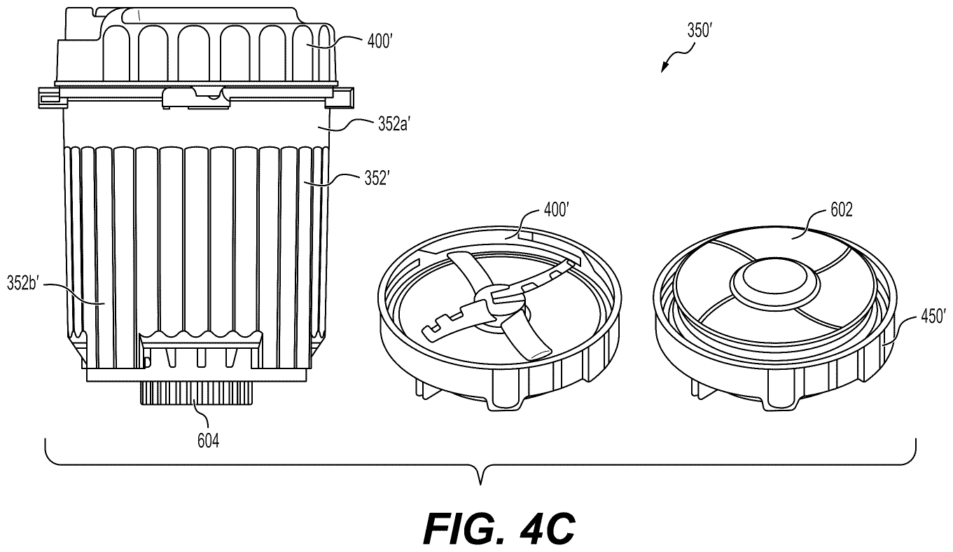

FIG. 3A shows an embodiment of the reversible bowl assembly 350″, assembled according to some embodiments of the disclosure. As shown in FIG. 3A, the bowl 352″ may have an oblong shape and include a cylindrical sidewall 358 defining an interior volume 360 of the bowl 352″. The sidewall 358 may extend between the first open end 352a″ of the bowl 352″ and the second open end 352b″ opposite the first open end 352a″. Embodiments of the sidewall 358 may have various configurations. For example, a cross-section of the sidewall may be circular or polygonal. In addition, a diameter of the sidewall may vary between the first open end 352a″ and the second open end 352b″ (e.g., may be tapered). The first open end 352a″ and the second open end 352b″ may communicate with the interior volume 360 of the bowl 352″. The assembly 350″ may further include a first lid 400′ removably couplable to the first open end 352a″ of the bowl 352″. The first lid 400′ may define an opening 401 (FIG. 3C) configured to couple to a blade 300 for mixing ingredients within the bowl 352″. When the bowl 352″ is installed to the coupling 500′ in the first configuration, the blade 300 may engage with the driven shaft 250′ to rotate and plunge the blade 300 within the ingredients. FIG. 3B shows an embodiment of the blade 300 coupled to the underside of first lid 400′. Some non-limiting examples of the blade 300 are shown in the '765 patent.

FIG. 3C is a cut-away view of the reversible bowl assembly 350″ and the first lid 400′, according to some embodiments of the disclosure, whereas blade 300 and a second lid 450′ are not shown in cut-away form. As shown in FIG. 3C, the blade 300 may include a central support hub 305 including a central opening 306 for engaging the driven shaft 250. In embodiments, the second lid 450′ may removably couple to the second open end 352b″ of the bowl 352″. The second lid 450′ may include, or be coupled to, a plunger 602 for pushing the ingredients in the bowl 352″ toward an opening 604 in first lid 400′. The plunger 602, alone or in combination with other components (e.g., the second lid 450′, the bowl 352″, or the nozzle 608), may constitute an extrusion assembly 600 for extruding processed ingredients from the bowl 352″. The opening 604′ in the first lid 400′ may further be in fluid communication with a nozzle (e.g. nozzle 608. For example, the opening 604′ may be in fluid communication with a nozzle through a conduit (e.g., plastic tubing) that extends from the opening 604′ to the nozzle. In embodiments, such a conduit may include one or more sections connected by joints (e.g., an elbow joint) to translate the direction (e.g., horizontal) of extrusion from opening 604 to a direction (e.g., vertically downward) of extrusion from the nozzle.

The plunger 602 may be couplable to the driven shaft 250′ of the micro-puree machine when the bowl assembly 350″ is in the second configuration and the bowl 352″ is installed to the coupling 500′. A surface of the plunger 602 facing the interior volume 360 may include a one or more (e.g., a plurality of) indentations 606. The indentations 606 may prevent frozen ingredients from rotational movement within the bowl 352″ during processing by the blade 300. The plunger 602 may furthermore include a flexible seal 610 around its perimeter to ensure contact (e.g., maximum contact) with the sidewall 358 of the bowl 352″ to allow for optimal (e.g., maximum) extrusion yield.

The micro-puree machine of the embodiments described in relation to FIGS. 2A, 2B, 3A-3D, 4B and 4B may include one or more motors and a transmission system (e.g., including gearing) that drive a driven shaft (e.g., driven shaft 250′) for engaging the blade assembly 300 and/or plunger 602 when the bowl assembly 350″ (coupled to lid 400′ or 450′, respectively) is coupled to the housing for processing or extruding, for example, as described in the '765 patent or the '965 patent; and may include gearboxes (e.g., high ratio gearboxes) and reinforced internals (not shown) to allow the extrusion assembly 600 to withstand high forces and extrude thick outputs from a nozzle.

FIG. 3D shows a detailed view of an embodiment of the plunger 602 coupled to the underside of second lid 450′. In embodiments, the bowl assembly 350″ may be configured such that only the first lid 400′ can couple to the first open end 352a″ of the bowl 352″ and only the second lid 450′ can couple to the second open end 352b″ of the bowl 352″. For example, a configuration of the threads 366 may be different from a configuration of the threads 368 (FIG. 3B) to prevent the user from attaching the wrong lid to the wrong side of the bowl 352″. The bowl 352″ may further include clear indicators (colors, icons, etc.) that would signal to the user which lid goes on which side of the bowl 352″.

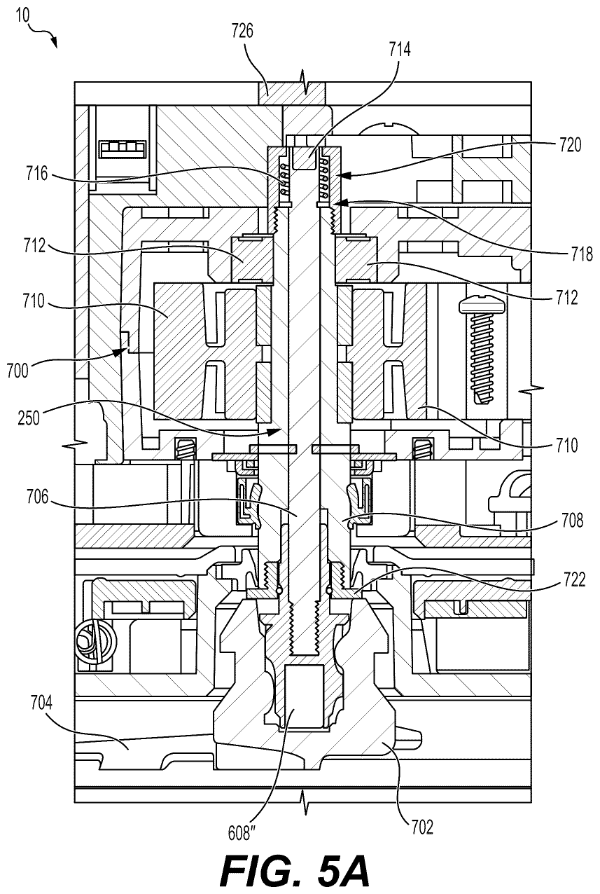

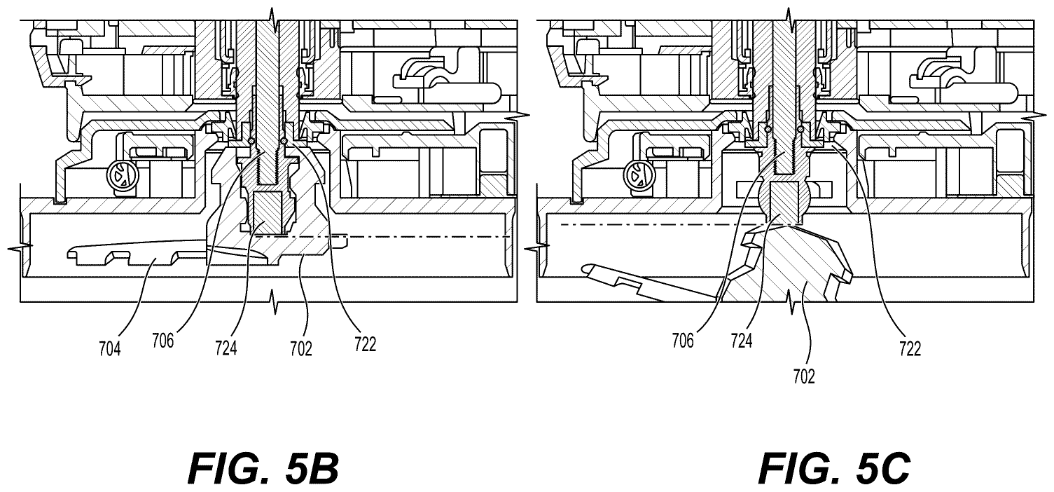

FIG. 4C illustrates the use of another bowl assembly 350′ including the extrusion assembly 600 according to some embodiments of the disclosure. As shown in FIG. 4C, the first end 352a′ of the bowl 352′ may be configured to couple to both the first lid 400′, and the second lid 450′. The second end 352b′ of the bowl 352′ may include a centrally located opening 604.

Advantageously, the micro puree machine 10 may include a sensor (not shown) that recognizes which lid is installed into the machine 10 to restrict certain programs based on the lid functions. For example, the user may only activate the blade 300 when the bowl 352 is installed in the first configuration and may only activate the plunger 602 when the bowl 352 is installed in the second configuration. This prevents user error when operating the machine 10.

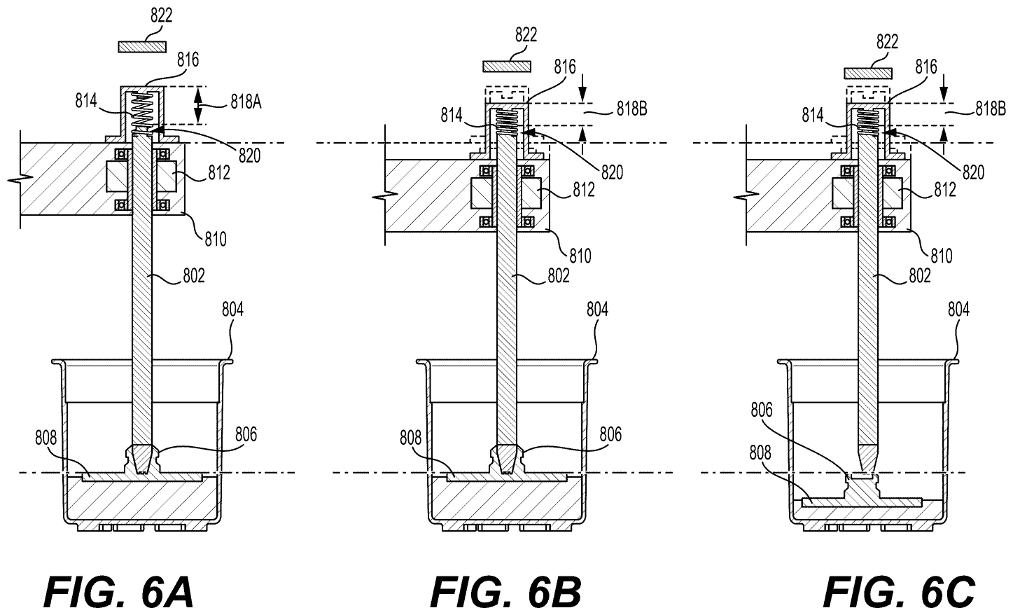

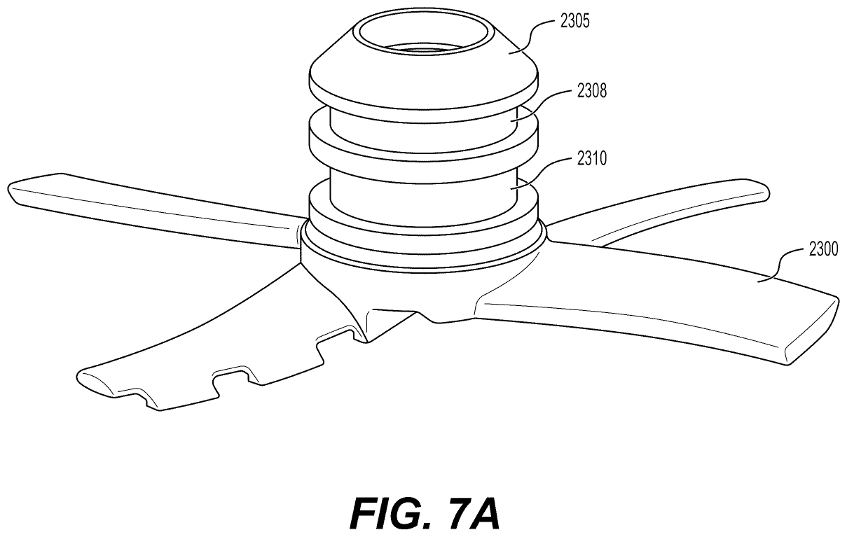

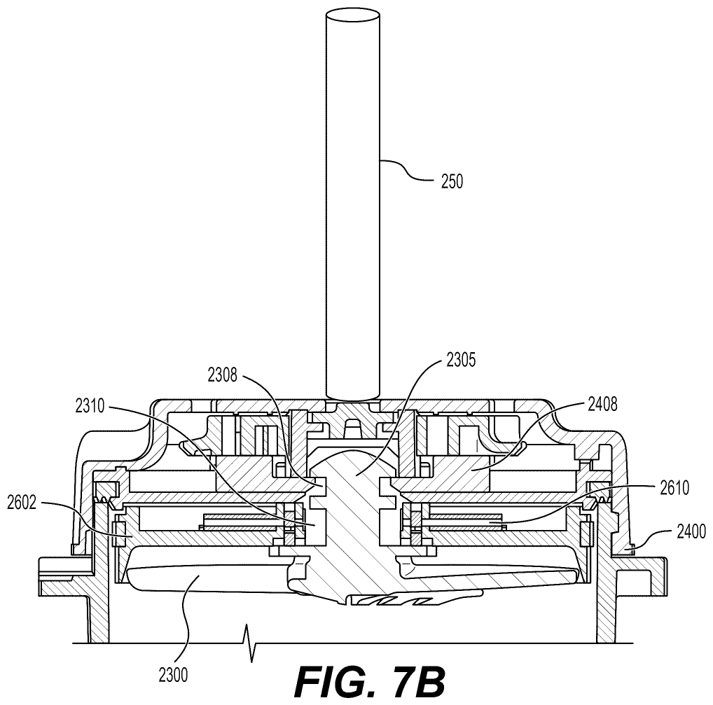

FIG. 5A is a cross-sectional view of machine 10 performing an example kill switch 700. The kill switch 700 includes drive and/or mixing shaft 250 positioned in machine 10. Shaft 250 is connected to coupling 702, which is used to connect shaft 250 to blade 704. Shaft 250 includes an inner shaft 706 and an outer shaft 708, which rotates in unison and provides the necessary rotational speed to blade 704 for chopping, stirring, or slicing food ingredients. A ballast 724 is positioned in a region between coupling 702 and inner shaft 706. Ballast 724 provides the support and balance needed for coupling 702 to be engaged with shaft 250. A bushing 722 is threaded to outer shaft 708. This caps the blade, preventing accidental triggering of kill switch 700.

A motor 710 is positioned around shaft 250 and produces the necessary power used by machine 10 to operate, including providing power to rotate shaft 250. A gearbox 712 is positioned around shaft 250, near motor 710, and transfers power from motor 710 to shaft 250. A magnet 714 is fixed on one end of inner shaft 706. Moreover, a spring 716 biases inner shaft 706, and a clip 718 provides a medium for spring 716 to act against. A bushing 720 is threaded to outer shaft 708, which caps spring 716. The arrangement of spring 716, clip 718, and bushing 720 allows magnet 714 and inner shaft 706 to move upwards and downwards within this arrangement. In some instances, pressure plates may be used in place of spring 216 and magnet 714 to detect upward displacement of inner shaft 704. A sensor 726 is configured to detect changes from magnet 714. Moreover, sensor 726 is positioned to minimize interference and maximize the detection of the magnetic fields of magnet 714. In some implementations, sensor 726 may be a Hall effect sensor 726 or the like.

FIG. 5B shows the arrangement of machine 10 when kill switch 700 is not activated. In this case, the coupling 702 remains attached to the shaft 250. FIG. 5C illustrates a case example when kill switch 700 is activated when blade 704 is dropped. Kill switch 700 is triggered when coupling 702 collides with a hard object resulting in blade 704 being decoupled from coupling 702. In other cases, blade 704 may be dropped due to not being connected properly to coupling 702. This causes ballast 724 and inner shaft 706 to move upwards. This, in turn, pushes magnet 714 upwards, which changes its magnetic fields indicating the resistive forces being exerted on inner shaft 706. Sensor 726 detects these changes in the magnetic fields to determine if the resistive forces on inner shaft 702 is significant enough to require shutting down machine 10 for safety reasons. Once the sensor 726 detects that the changes in magnetic field surpass a threshold requiring machine 10 to be shutdown, it triggers the shutdown of motor 710.

Magnet 714 and sensor 726 operate similarly like a microswitch, which either keeps machine 10 running or turning off machine 10 when inner shaft 706 has experienced a specified amount of hazardous resistive forces due to blade 704 being dropped or unable to process food ingredients.

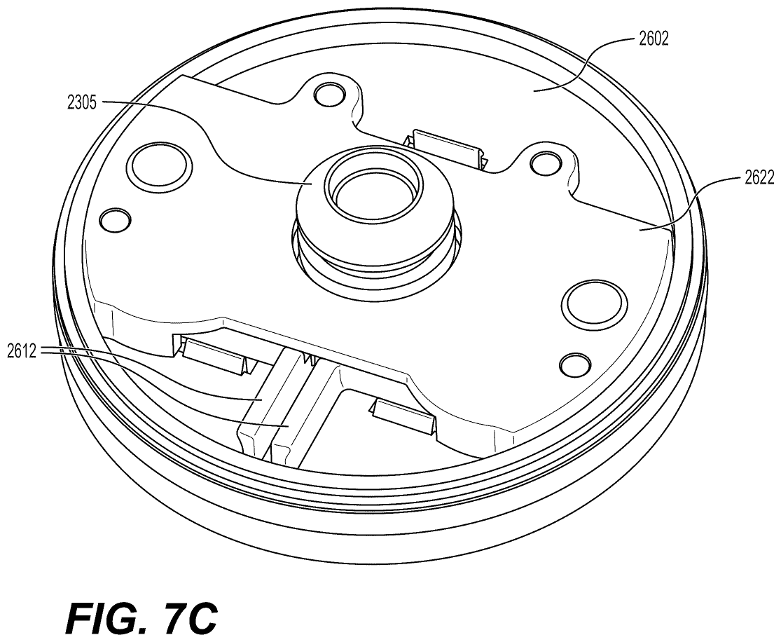

FIGS. 6A-6C are schematic diagrams of the details of performing an example kill shaft technique in machine 10. The kill shaft technique involves measuring resistive forces being experienced by a shaft 802. When the resistive forces are too high machine 10 is shut down. In particular, FIG. 6A shows machine 10 during normal operations. Inner shaft 802 is securely placed in a bowl 804 for processing food ingredients. Coupling 806 connects inner shaft 802 to blade 808. Bowl 804 is configured to received the food ingredients, including frozen food ingredients. Depending on the user's preference, blade 808 may dice, mince, cut, or blend the food ingredients in bowl 804 to make ice cream. A motor 810 is positioned around inner shaft 802 and produces the necessary power used by machine 10 to operate, including providing power to rotate shaft 802. A gearbox 812 is positioned around inner shaft 802, near motor 810, and transfers power from motor 810 to shaft 802. In one implementation, a spring 814 is fixed on the top end of shaft 802. A portion of shaft 802 and spring 814 are positioned within bushing 816. The arrangement of spring 814 and bushing 816 allows for inner shaft 802 to move up or down biased by spring 814 within bushing 816. Spring 814 is preloaded in normal operation to a partially compressed state, by a normal operation force, with a length defined by the normal gap in bushing 816. During normal operations, shaft 802 is sprung down by spring 814. Gearbox 812 and shaft 802 move together if the resistance from the ingredients of the ice cream is in the normal operation range. A magnet 820 is fixed on one end of inner shaft 802 to detect changes in the normal gap. A sensor may be positioned with machine 10 to minimize interference and maximize the detection of the magnetic fields of magnet 820. In some implementations, the sensor may be a Hall effect sensor or the like.

In other implementations, spring 814 may be used to detect deviation. The deviation may be detected by monitoring the partial deflection of spring 814 or electrically monitoring the force on spring 814.

FIG. 6B shows an instance when the ingredients in bowl 804 are excessively hard leading to possible damage to inner shaft 802, blade 808, gear 812, and motor 810, or other internal components machine 10. In this case, gearbox 812 continues to drive downwards but the blade 808 and inner shaft 802 are stopped due to too the hard ingredients leading to blade 808 being dropped or damaged. This causes the inner shaft 802 to be pushed upwards compressing spring 814 and reducing the gap in bushing 816 resulting in variations of the magnetic fields of magnet 820, which are detected by the sensor. The smaller the size of the reduced gap 818B the more resistive forces being experienced by shaft 802. To prevent damage to machine 10, a threshold, associated with the detected variations of the magnetic fields of magnet 820, may be assigned to the reduced gap 818B to indicate inner shaft 802 is experiencing very dangerous resistive forces requiring motor 810 to stop providing power to inner shaft 802.

FIG. 6C shown an instance when inner shaft 802 is not properly connected to blade 808. This may occur either after the proper connection between shaft 802 and blade 808, where disruption occurs, causing blade 808 to be dislodged from shaft 802, or blade 808 is initially improperly connected to shaft 802 prior to operation. This results in gearbox 812 continuing to drive downwards but inner shaft 802 is prevented from moving downward due to blade 808. This causes the shaft 802 to be pushed upwards compressing spring 814 and reducing the gap in bushing 816 resulting in variations of the magnetic fields of magnet 820, which are detected by the sensor. As mentioned in FIG. 6C, the smaller the size of the reduced gap 818B the more resistive forces being experienced by inner shaft 802. To prevent damage to machine 10, a threshold, associated with the detected variations of the magnetic fields of magnet 820, may be assigned to the reduced gap 818B to indicate shaft 802 is experiencing very dangerous resistive forces by disengaging motor 810 from providing power to inner shaft 802. This protects from damage inner shaft 802, blade 808, gear 812, motor 810, and other internal components machine 10.

Magnet 820 and sensor 822 operate similarly like a microswitch, which disengages inner shaft 802 from motor 810 when inner shaft 802 experiences a specified amount of hazardous resistive forces due to blade 704 being dropped or unable to process food ingredients.

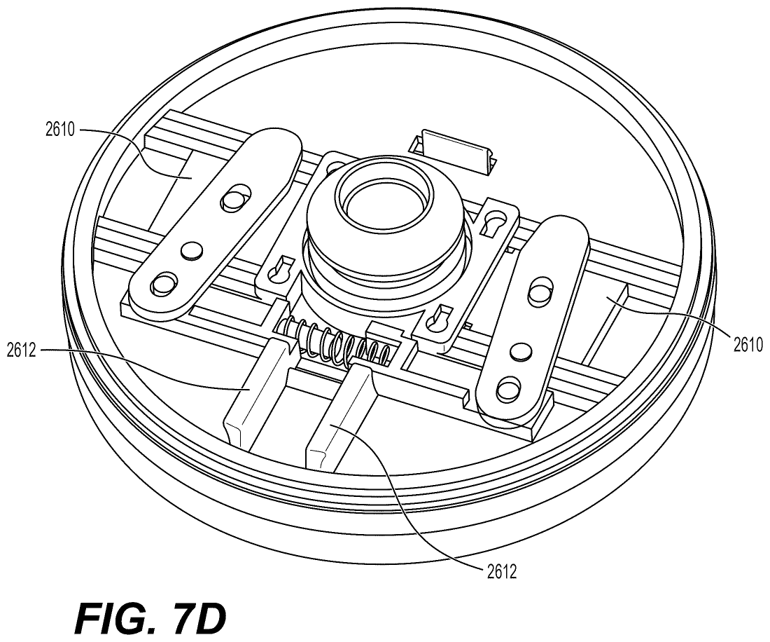

FIGS. 7A-7D illustrate an example extended shaft 250 used to determine if a blade assembly 2300 is properly positioned in a lid 2400. As shown in FIG. 7A, the central support hub 2305 of the blade assembly 2300 may include an upper groove 2308 and a lower groove 2310. As shown in FIG. 7B, the lid 2400 may include a first set of engagement features, such as primary clips 2408, that are biased (e.g., spring biased) toward the central support hub 2305. As the user installs the blade assembly 2300 to the lid 2400, the primary clips 2408 may engage the upper groove 2308 of the central support hub 2305. In this configuration, a second set of engagement features on the plunger 2602, such as secondary clips 2610, are disengaged from the lower groove 2310 such that the blade assembly 2300 can be driven axially and rotationally by the driven shaft 250 independent of the plunger 2602.

FIGS. 7C-7D illustrate the configuration and movement of the secondary clips 2610 according to some embodiments of the disclosure. As shown in FIG. 7C, an upper surface of the plunger 2602 may comprise a set of moveable magnetic levers 2612 disposed within a housing 2622 that is configured to allow for passage of the central support hub 2305. As shown in FIG. 7D, the levers 2612 may be operatively coupled to the secondary clips 2610 such that the levers 2612 are positioned apart when the secondary clips 2610 are engaged with the lower groove 2310.

Extended shaft 250 is configured to enable detection of whether the blade assembly 2300 is properly positioned within the lid 2400, not whether the blade assembly 2300 is connected to the shaft 250. Shaft 250 is extended vertically to ensure that the blade assembly is not partially connected to shaft 250 by, for example, by pushing a partially connected blade assembly 2300 from lid 2400 before detection of the blade levers 2612 is performed. If blade assembly 2300 is fully engaged with clips 2408 or 2610 of lid 2400, the extended blade shaft 250 properly engages with blade assembly 2300 while the lever's position is rotated such that its magnetic field is in a sufficiently close position to trigger sensors, such as sensors 726 or 822, indicating that blade assembly 2300 is properly and/or fully engaged within lid 2400. If the blade assembly is not fully or properly engaged with clips 2408 or 2610 of lid 2400, extended blade shaft 250 will not properly engage with blade assembly 2300, pushing down on and causing extended blade shaft 250 to disengage blade assembly 2300 from clips 2408 or 2610 of lid 2400 which, in turn, causes levers 2612 to move to the “no blade” position. Thus, when the container is rotated to the upward/engaged position, the lever magnet is not in a sufficiently closed position to trigger a sensor.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

We claim:

1. A food processing system comprising:
a housing;
a drive shaft extending from the housing, the drive shaft including a first end configured to receive a blade assembly and a second end opposing the first end; and
at least one sensor configured to detect a position of the second end of the drive shaft to determine if the blade assembly is coupled to the drive shaft or not.

2. The food processing system of claim 1, wherein the second end of the drive shaft is in a first position relative to the sensor when the blade assembly is coupled to the drive shaft and the second end of the drive shaft is in a second position relative to the sensor when the blade assembly is not coupled to the drive shaft.

3. The food processing system of claim 2, wherein the sensor determines if the blade assembly is coupled to the drive shaft or not coupled to the drive shaft by determining if the second end of the drive shaft is in the first position or the second position.

4. The food processing system of claim 3, wherein the sensor determines that the blade assembly is not coupled to the drive shaft by detecting a magnetic field within its proximity caused a magnet positioned at about the second end of the drive shaft.

5. The food processing system of claim 3, wherein the sensor determines that the blade assembly is coupled to the drive shaft by determining an absence of a magnetic field within its proximity.

6. The food processing system of claim 5, wherein the drive shaft is coupled to at least one spring.

7. The food processing system of claim 6, wherein the at least one spring is configured to exert a force against the drive shaft that pushes the second end of the drive shaft toward the sensor.

8. The food processing system of claim 7, wherein when the blade assembly is coupled to the drive shaft, the force of the at least one spring is overcome by the coupling of the blade assembly to prevent the at least one spring from pushing the second end of the drive shaft toward the sensor.

9. The food processing system of claim 8, wherein when the blade assembly is decoupled from the drive shaft, a force of the at least one spring pushes the second end of the drive shaft into sufficient proximity of the sensor whereby the sensor detects the magnetic field of the magnet and the sensor determines that the blade assembly is not coupled to the drive shaft.

10. A food processing system comprising:
a housing;
a drive shaft extending from the housing, the drive shaft including a first end configured to receive a blade assembly and a second end opposing the first end;
at least one sensor configured to detect a position of the second end of the drive shaft
wherein the second end of the drive shaft is in a first position relative to the sensor when the drive shaft is extending into a mixing container and the second end of the drive shaft is in a second position relative to the sensor when movement of the drive shaft into the container is inhibited by a threshold resistive force.

11. The food processing system of claim 10, wherein the threshold resistive force is determined by a spring force of at least one spring coupled to the drive shaft.

12. The food processing system of claim 11, wherein the at least one spring provides a force that pushes the drive shaft away from the sensor.

13. The food processing system of claim 10, wherein the resistive force is caused by at least one of a dropped blade assembly, a hard object, and a hard food product.

14. The food processing system of claim 10, further comprising a controller, wherein when the sensor detects that the threshold resistive force has been reached or exceeded, the controller deactivates the drive motor and a position motor.

15. The food processing system of claim 10, wherein the resistive forces, using the at least one sensor, are determined by changes in length of at least one spring in the housing.

16. The food processing system of claim 15, wherein when the changes in the length of the at least one spring surpasses a threshold, power to the drive motor is ceased.

17. A food processing system comprising:
a lid;
a blade assembly within the lid;
an extended drive shaft configured to determine whether the blade assembly is fully engaged within the lid, wherein when the blade assembly is not fully engaged with the lid, the extended drive shaft fully disengages the blade assembly from the lid and a drive motor ceases further operation, otherwise the extended drive shaft fully engages with the blade assembly to perform a food processing operation.

18. The food processing system of claim 17, wherein when the extended drive shaft is fully engaged with the blade assembly, at least two clips of the lid are engaged with the extended drive shaft.

19. The food processing system of claim 17, wherein the lid includes at least one lever and wherein when the extended drive shaft is fully engaged with the blade assembly and the blade assembly is fully engaged with the lid, the at least one lever of the lid is rotated to an actuating position.

20. The food processing system of claim 17. wherein the lid includes at least one lever and wherein when the extended drive shaft is not fully engaged with the blade assembly and pushes the blade assembly out of the lid, the at least one lever of the lid is rotated to a non-actuating position.
